(19) United States
(12) Patent Application Publication
(10) Pub. No.: US 2022/0180323 A1
(43) Pub. Date: Jun. 9, 2022

(54) SYSTEM AND METHOD FOR GENERATING JOB RECOMMENDATIONS FOR ONE OR MORE CANDIDATES

(71) Applicant: O5 Systems, Inc., Toronto (CA)

(72) Inventors: Riccardo Di Sipio, York (CA); Lena Shulamit Umansky, Toronto (CA); Paul Michael Inder, Toronto (CA); David Wahiche, Mississauga (CA); Matthew Sergeant, East York (CA); David Jorjani, Toronto (CA); Nemanja Stefanovic, Toronto (CA); Shaun Christopher Ricci, Toronto (CA); Somen Mondal, Toronto (CA)

(21) Appl. No.: 17/112,823

(22) Filed: Dec. 4, 2020

(51) Int. Cl. G06Q 10/10; G06K 9/62; G06N 3/04

(52) U.S. Cl. CPC G06Q 10/1053; G06K 9/6248; G06N 3/0454; G06K 9/627; G06K 9/6215

(57) ABSTRACT

A computer system, computer program product and computer-implemented method for generating job recommendations for one or more candidates or applicants. The system is configured to generate a candidate, e.g. prospective candidate, vector comprising embedded data or information associated with the candidate. The prospective candidate vector is compared to vectors with embedded data for other applicants to match the prospective candidate with past applicants or candidates and generate a list of past applicants and/or the jobs applied for by the past applicants, and to generate a job title vector comprising the job titles. According to an exemplary implementation, the system is configured to generate a baseline recommendation utilizing the job title vector and comprising a plurality of open jobs with a ranking or score for the prospective candidate. According to another aspect, the system is configured to re-rank the open jobs and the recommendation based on additional data and/or weighting factors.

### FIELD OF THE INVENTION

The present invention relates to computer systems and more particularly, to a computer-implemented system and method configured for generating one or more job recommendations for one or more candidates or applicants.

### BACKGROUND OF THE INVENTION

It is estimated that people currently in the workforce will change their job on average between 10 and 20 times over their lifetime. From the perspective of devising a job recommendation system, this observation leads to the fact that a prospective candidate may apply to one or just a very few positions at a given company, i.e. information about applications will typically be very sparse along a “user axis”. Any system will need to infer information about the candidate from other sources, usually conveyed by the candidate's resume and/or from answers to screening questions.

It will therefore be appreciated that there remains a need for improvements in the art.

### BRIEF SUMMARY OF THE INVENTION

The present invention is directed to a method and system for generating job recommendations for a candidate or job applicant.

According to an exemplary embodiment, a computer system, a computer program product and a computer-implemented method is provided for generating job recommendations for one or more candidates or applicants. The system is configured to generate a candidate, e.g. prospective candidate, vector comprising embedded data or information associated with the candidate. The prospective candidate vector is compared to vectors with embedded data for other applicants to match the prospective candidate with past applicants or candidates and generate a list of past applicants and/or the jobs applied for by the past applicants. The system is configured to generate a job title vector comprising the job titles. According to an exemplary implementation, the system is configured to generate a baseline recommendation utilizing the job title vector and comprising a plurality of open jobs with a ranking or score for the prospective candidate. According to another aspect, the system is configured to re-rank the open jobs and the recommendation based on additional data and/or weighting factors.

According to an embodiment, the present invention comprises a computer-implemented system for determining a recommendation for a candidate for a selected job in an organization, said system comprising: a processor operatively coupled to a database and including an input component configured to retrieve data associated with the candidate; a first network configured to generate a first vector comprising a representation of said data associated with the candidate, said first vector having a first dimension; a second network configured to generate a second vector based on said first vector, said second vector comprising a second dimension, and said second dimension being less than the first dimension of said first vector; said processor including a comparison component configured to compare said second vector to one or more vectors wherein each of said one or more vectors represents a job in the organization; and said processor including a component configured to be responsive to said comparison component and generate a match rating based on the comparison of said second vector and said one or more job vectors.

According to another embodiment, the present invention comprises a computer program product for determining a recommendation for a candidate for a selected job in an organization said computer program product comprising: a non-transitory storage medium configured to store computer readable instructions; said computer readable instructions including instructions for, inputting data from a database associated with the candidate for the selected job; generating a first vector comprising a representation of said data associated with the candidate, said first vector having a first dimension; generating a second vector based on said first vector, said second vector comprising a second dimension, and said second dimension being less than the first dimension of said first vector; comparing said second vector to one or more vectors wherein each of said one or more vectors represents a job in the organization; and generating a match rating based on the comparison of said second vector and said one or more job vectors.

According to yet another embodiment, the present invention comprises a computer-implemented method for determining a recommendation for a candidate for a selected job in an organization said method comprising the steps of: inputting data from a database associated with the candidate for the selected job; generating a first vector comprising a representation of said data associated with the candidate, said first vector having a first dimension; generating a second vector based on said first vector, said second vector comprising a second dimension, and said second dimension being less than the first dimension of said first vector; comparing said second vector to one or more vectors wherein each of said one or more vectors represents a job in the organization; and generating a match rating based on the comparison of said second vector and said one or more job vectors.

Other aspects and features of the present invention will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example, embodiments of the present invention, and in which:

FIG. 1 shows in diagrammatic form an exemplary network-based configuration suitable for implementing a system and a method according to embodiments of the present invention;

FIG. 2 shows in block diagram form an exemplary implementation of a system according to an embodiment of the present invention;

FIG. 3 shows in diagrammatic form a process for generating a candidate vector for configured for determining a job recommendation for the candidate according to an embodiment of the present invention;

FIG. 4 shows in diagrammatic form a process for determining a recommendation utilizing the candidate vector as generated;

FIG. 5A shows in flow-chart form a process for performing a deep search and extracting information associated with a candidate according to an embodiment of the present invention;

FIG. 5B shows in flow-chart from a process for performing a quick search and extracting information associated with a candidate according to an embodiment of the present invention;

FIG. 5C shows in diagrammatic form a re-ranking module or process according to an embodiment of the present invention;

FIG. 6 shows in diagrammatic form a process for pre-processing information associated with candidates applying for one or more jobs according to an embodiment of the present invention;

FIG. 7 shows in diagrammatic form a process for generating a best-match based on past jobs vector for a candidate according to an embodiment of the present invention;

FIG. 8 shows in diagrammatic form a process for generating a best-match for open jobs vector for a candidate according to an embodiment of the present invention;

FIG. 9 shows in diagrammatic form a process for refining recommendations for a candidate according to an embodiment of the present invention; and

FIG. 10 shows in diagrammatic form a process for generating a grading or preliminary grading according to an embodiment of the present invention.

Like reference numerals indicate like or corresponding elements or components in the drawings.

### DETAILED DESCRIPTION OF THE EMBODIMENTS OF THE INVENTION

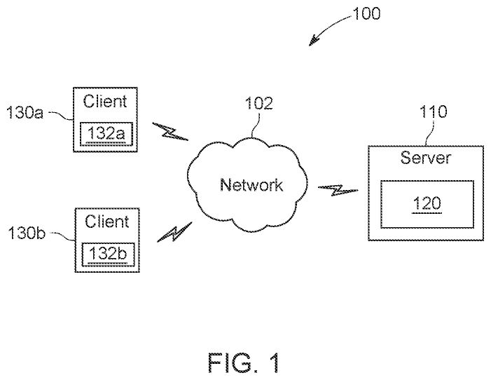

Reference is first made to FIG. 1, which shows an exemplary network-based and computer-based implementation of the system for generating a recommendation for a candidate, for instance, an employment position or other job function, and indicated generally by reference 100. The system 100 comprises a server (or one or more servers) indicated generally by reference 110 coupled to one or more client machines or computers 130, indicated individually by references 130a and 130b in FIG. 1, operatively coupled through a network indicated generally by reference 102.

The client machine or appliance 130 may include a device, such as a personal computer, a wireless communication device or smart phone, a portable digital device such as an iPad or tablet, a laptop or notebook computer, or another type of computation or communication device or appliance, a thread or process running on one of those devices, and/or an object executable by one of these devices. The server 110 may include a server application or module 120 configured to gather, process, search, and/or maintain a graphical user interface (GUI) and functionality (e.g. web pages) in a manner consistent with the embodiments as described in more detail below.

The network 102 may comprise a local area network (LAN), a wide area network (WAN), a telecommunication network, such as the Public Switched Telephone Network (PSTN), an Intranet, the Internet, or a combination of networks. According to another aspect, the system 100 may be implemented as a cloud-based system or service utilizing the Internet 102.

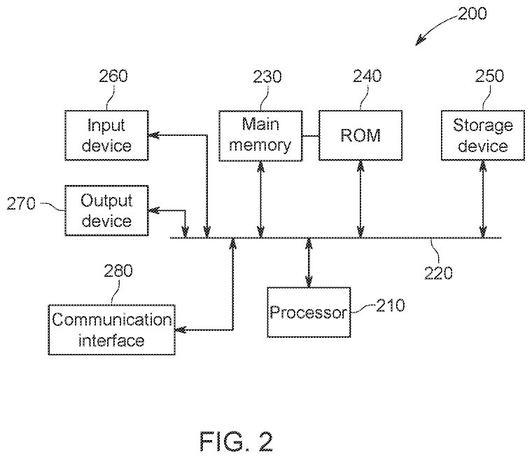

Reference is next made to FIG. 2, which shows an exemplary implementation for a client or server entity (i.e. a “client/server entity”), which may correspond to one or more of the servers (e.g. computers) 110 and/or client machines or appliances (e.g. computers) 130, in accordance with the functionality and features of the embodiments as described in more detail below. The client/server entity is indicated generally by reference 200 and comprises a processor (e.g. a central processing unit or CPU) 210, a bus 220, a main memory 230, a read only memory or ROM 240, a mass storage device 250, an input device 260, an output device 270, and a communication interface 280. The bus 220 comprises a configuration (e.g. communication paths or channels) that permits communication among the elements or components comprising the client/server entity 200.

The processor 210 may comprise a hardware-based processor, microprocessor, or processing logic that is configured, e.g. programmed, to interpret and/or execute instructions. The main memory 230 may comprise a random-access memory (RAM) or other type of dynamic storage device that is configured to store information and/or instructions for execution by the processor 210. The read only memory (ROM) may comprise a conventional ROM device or another type of static or non-volatile storage device configured to store static information and/or instructions for user by the processor 210. The storage device 250 may comprise a disk drive, solid state memory or other mass storage device such an optical recording medium and its corresponding drive or controller.

The input device 260 may comprise a device or mechanism configured to permit an operator or user to input information to the client/server entity, such as a keyboard, a mouse, a touchpad, voice recognition and/or biometric mechanisms, and the like. The output device 270 may comprise a device or mechanism that outputs information to the user or operator, including a display, a printer, a speaker, etc. The communication interface 280 may comprise a transceiver device or mechanism, and the like, configured to enable the client/server entity 700 to communicate with other devices and/or systems. For instance, the communication interface 280 may comprise mechanisms or devices for communicating with another machine, appliance or system via a network, for example, the Internet 102 (FIG. 1).

As will be described in more detail below, the client/server entity 200, in accordance with embodiments according to the present invention, may be configured to perform operations or functions relating to the process of selecting a suitable candidate, to the process of generating a candidate model or template, and the other functions as described or depicted herein. The client/server 200 may be configured to perform these operations and/or functions in response to the processor 210 executing software instructions or computer code contained in a machine or computer-readable medium, such as the memory 230. The computer-readable medium may comprise a physical or a logical memory device or medium.

The software instructions or computer code may be read into the memory 230 from another computer-readable medium, such as a data storage device 250, or from another device or machine via the communication interface 280. The software instructions or computer code contained or stored in the memory 230 instruct, or cause, the processor 210 to perform or execute processes and/or functions as described in more detail herein. In the alternative, hardwired circuitry, logic arrays, and the like, may be used in place of or in combination with software instructions to implement the processes and/or functions in accordance with the embodiments of the present invention. Therefore, implementations consistent with the principles of the embodiments according to the present invention are not limited to any specific combination of hardware and/or software.

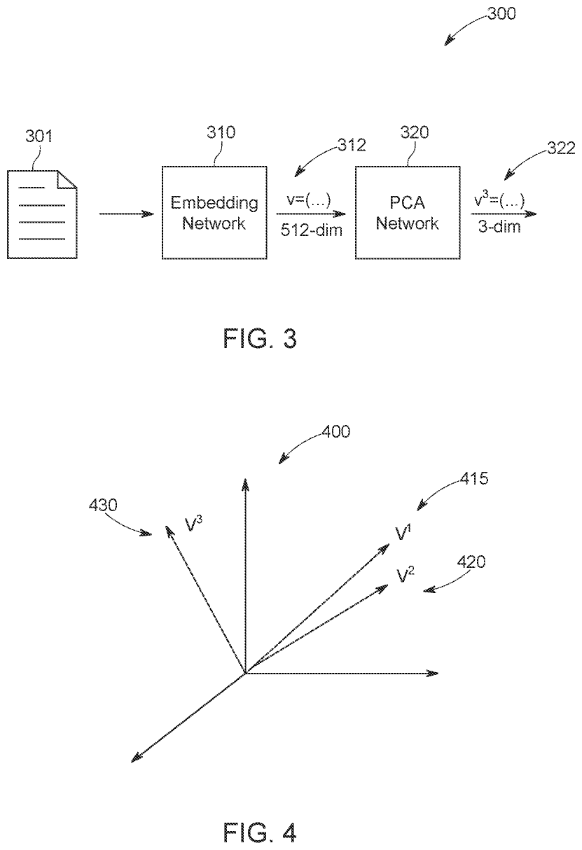

Reference is next made to FIG. 3, which shows in diagrammatic form a process for generating a candidate vector configured for determining a job recommendation for the candidate according to an embodiment of the present invention and indicated generally by reference 300. The candidate vector is utilized by the system and associated functional modules to generate one or more job recommendations as described in more detail below. As shown in FIG. 3 and according to an exemplary implementation, the process for generating a candidate vector 300 comprises a first neural network indicated by reference 310 and a second neural network indicated by reference 320. The first neural network 310 is configured to generate a vectorial representation, i.e. “a vector”, indicated generally by reference 312 based on information or data retrieved, extracted or parsed, from a candidate file, record or document, indicated generally by reference 301, for example, a candidate resume or a job description. According to an exemplary implementation, the first neural network 310 comprises a pre-trained neural network configured to generate vectors based on “Universal Sentence Embedding” or USE transform, as will be described in more detail below. According to an exemplary implementation, the vector or vectorial representation 312 generated by the first neural network 310 comprises a 512-dimensional vector. The second neural network 320 is configured to generate or project the 512-dimensional vector 312 to a second or final vector indicated generally by reference 322 having a smaller number of dimensions. According to an exemplary implementation, the second, i.e. the resultant or final vector, 322 comprises a vector with reduced dimensions, for example, a 3-dimensional vector, and the second neural network 320 is configured to execute a “non-linear principle component analysis”, or NL-PCA, transform, as will be described in more detail below. The second neural network 320 is trained using data or information already stored or present in a database for other users, e.g. candidates, and/or job titles or positions. The second or final vector 320 comprising a three-dimensional vector becomes more manageable and is used to match candidates to available jobs or job openings, as described in more detail below.

Reference is next made to FIG. 4, which shows in diagrammatic form a process for matching a prospective candidate to other applicants and/or jobs, and indicated generally by reference 400. According to an exemplary embodiment, the process 400 is configured to match a prospective candidate represented by an embedding vector V1 (indicated by reference 410) to other applicants by determining proximity of one or more embedding vectors associated with other applicants, for instance embedding vector V2 (indicated by reference 420) and embedding vector V3 (indicated by reference 430) of other applicants utilizing a “cosine similarity” or a “cosine proximity” operation to generate a number or score between zero (0) and one (1), with a score of 1 being “good” and a score of 0 being “bad”. A match is determined by the angle between vectors which is normalized between 0 and 1. For the example depicted in FIG. 4, the vector 12 or 420 is “close” to the prospective candidate vector V1 or 410 and therefore the vector V2 is a good match. The embedding vector V3 (or 430) is not “close” to the prospective candidate vector V1, and is therefore not a good match, i.e. the normalized score is zero or close to zero.

According to another aspect, the system is configured to compile or generate a list or group of similar past applicants, then analyze the jobs or positions applied for by the similar past applicants and generate a job title vector. According to an exemplary implementation, the job titles vector is generated utilizing the first neural network and the second neural network and job titles or descriptions already present in the database, as will be described in more detail below. The job titles embedding vector is matched to open jobs or positions utilizing the cosine similarity or proximity function (for example, as described above for FIG. 4). According to an exemplary implementation, the system generates a baseline recommendation comprising a plurality (e.g. 5) open jobs with the highest scores, e.g. score of one or close to score of one, as described in more detail below.

According to another aspect, the system is configured to refine the baseline recommendation. According to an exemplary implementation, the system is configured to execute or perform a re-weighting operation or function comprising applying re-weighting factors to the baseline recommendation. For example, the re-weighting factors may include: geographic ‘distance’ from the job location; level of seniority for the job (e.g. a junior vs a senior position); ‘consistency’ with other candidates and/or jobs for similar positions; and/or preferred ‘language’ (e.g. English or French). The re-weighting operation comprises multiplying the baseline recommendation or score for each recommended job by a number that is calculated or based on or more of the re-weighting factors, for instance as listed above, and described in more detail below.

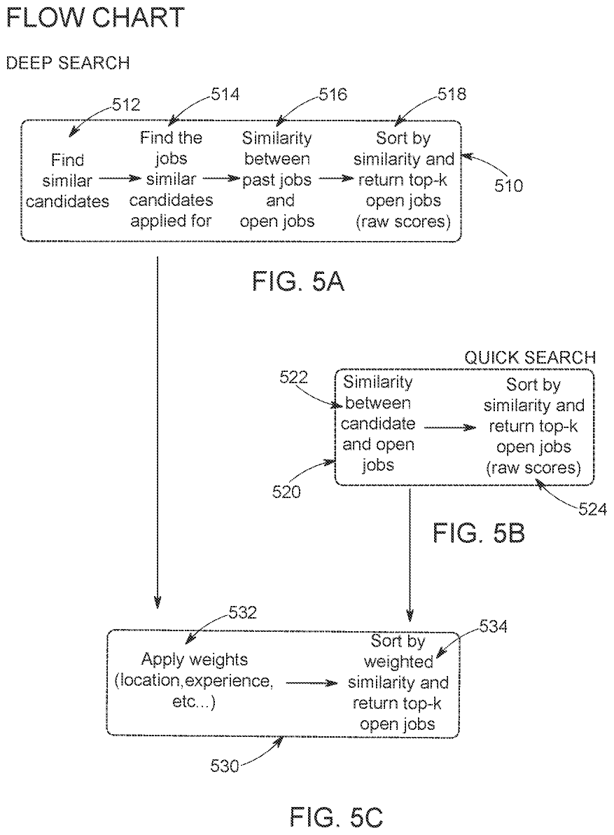

Reference is next made to FIG. 5A, which shows a ‘deep search’ process for generating a baseline recommendation indicated generally by reference 510. As shown in FIG. 5A, the deep search process 510 comprises finding similar candidates as indicated by reference 512 and finding the jobs the similar candidates applied for as indicated by reference 514. The next step involves determining past job(s) for the similar candidates that are similar to currently open job(s), as indicated by reference 516. The next step, as indicated by reference 518, involves sorting, e.g. matching, the similar currently open jobs and generating a list of the top open jobs (i.e. top-K list or baseline recommendation) for the prospective candidate based on the raw scores, e.g. based on cosine proximity or cosine similarity operation as described above.

Reference is made to FIG. 5B, which shows a ‘quick search’ process for generating a baseline recommendation according to an embodiment of the present invention, and indicated generally by reference 520. As shown, the quick search process 520 involves determining similarity between the prospective candidate and open or available jobs or positions, as indicated by reference 522. The next step in the quick search process 520 involves sorting or matching the similar currently available jobs to the prospective candidate and based on the raw scores generating a list of the top open jobs (i.e. top-K list or baseline recommendation) for the prospective candidate.

As shown in FIG. 5C, the system may also be configured with a re-ranking module or process as indicated by reference 530. According to an embodiment, the re-ranking module 530 comprises a reweighting operation indicated by reference 532 involving applying one or more weighting factors to the baseline score or recommendation to generate a refined or more accurate top-K list. As described above, the weighting factors may include one or more of the following: geographic distance or location of the candidate in relation to the job venue or location; level of seniority, e.g. a junior position or a senior or management position; consistency between the prospective candidate and other candidates and/or jobs for similar positions; and/or preferred language, e.g. English or French. Following the reweighing operation 532, the re-ranking module 530 performs a sorting or matching operation indicated by reference 534. The sorting operation 534 comprises sorting the weighted or refined baseline recommendations and returning (i.e. generating) a refined top-K list of open jobs for the prospective candidate.

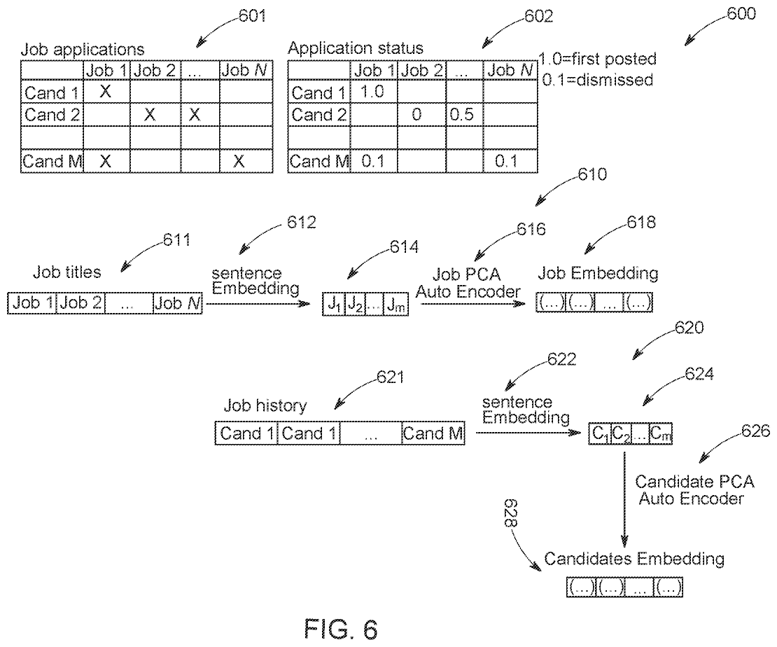

Reference is next made to FIG. 6, which shows in diagrammatic form pre-processing operations according to an embodiment of the present invention and indicated generally by reference 600. The pre-processing operations comprise a process for generating a job embeddings vector indicated generally by reference 610 and a process for generating a candidates embeddings vector indicated generally by reference 620.

As shown in FIG. 6, the system comprises a job applications database 601 and an application status database indicated by reference 602. The job applications database 601 comprises a job applications record for each candidate, for example, “Cand 1” applied for “Job 1”, “Cand 2” applied for “Job 2” and for “Job 3”, “Cand M” applied for “Job 1” and for “Job N”.

The application status database 602 comprises an application status record for each candidate, for instance as shown, “Cand 1” application for “Job 1” is ranked 1.0 (i.e. first-posted), “Cand 2” applications for “Job 2” is marked 0 (i.e. dismissed). According to an exemplary embodiment, the application status database 602 is implemented as a relational database and comprises separate tables for jobs, for candidates and for applications, and each table includes details of each of the objects comprising fields and json data. The applications reference the job and the candidate objects. According to another aspect, the system is configured to map the application status in an Applicant Tracking System (ATS) to internal status mappings for instance through user actions on a user interface (UI). This is utilized to determine which application statuses become first posts or dismissed without contact. According to an exemplary implementation, a first post is an applicant that has been selected to proceed forward in the application process, for example, moving to an interview. The first post is utilized as a positive training example for the machine learning algorithm(s). In contrast, an applicant that is dismissed is not selected to proceed. In particular, an applicant dismissed without contact represents an applicant that was dismissed for a negative reason, for instance, an applicant not having proper qualifications, or for example, an applicant having a poor resume. The dismissed without contact are utilized as negative training examples for the machine learning algorithm(s). According to another aspect, an applicant can be dismissed for instance if the job is closed, but the applicant may still have a good resume, and as such would not be a negative training example for the machine learning algorithms.

As shown in FIG. 6, the process for generating a job embeddings vector 610 comprises determining a plurality or list of job titles, as indicated by reference 611, for instance, based job application data or information from the job applications database 601. The next step as indicated by reference 612 comprises generating a first job embeddings (i.e. embedding sentence) vector as indicated by reference 614 utilizing a neural network, such as the first neural network 310 (as described above and shown in FIG. 3), configured to generate the first vector 614 based on Universal Sentence Embedding or USE as described above. The first job embeddings vector 614 is further optimized, for example, from a 512-Dimensional vector to 3-Dimensional vector as described above, for instance, by applying a non-linear principal component analysis or NL-PCA in a second neural network 320, as also described above. The second neural network 320 is trained utilizing data from other jobs and/or job titles stored or present in the database, e.g. an enterprise database, company database or similar data repositories or storage systems. According to this aspect, the second neural network is trained or configured to execute a PCA encoding operation to generate a smaller or lower dimension second job embeddings vector, as indicated by reference 618 in FIG. 6.

Similarly, the process for generating a candidates embeddings vector 620 comprises determining job histories for the candidates, as indicated by reference 621 in FIG. 6. The job histories may be derived from data or information from the application status database 602. As shown and indicated by reference 622 comprises generating a first candidate embeddings (i.e. embedding sentence) vector as indicated by reference 624 utilizing a neural network, such as the first neural network 310 (as described above and shown in FIG. 3), configured to generate the first vector 624 based on Universal Sentence Embedding or USE neural network, as described above. As will be understood by those skilled in the art, USE is described in more detail at https://arxiv.rog/abs/1803.11175. According to an exemplary implementation, the network is pre-trained by Google and accessed at https://tfhub.dev/google/universal-sentence-encoder/1. As will be understood by those skilled in the art other neural networks or configurations may be utilized, for example, BERT. The first candidate embeddings vector 624 is further optimized, for example, optimized from a 512-Dimensional vector to 3-Dimensional vector as described above, for instance, by applying a non-linear principal component analysis or NL-PCA in a second neural network 320, as also described above. The second neural network 320 is trained utilizing data from other applications stored or accessible in the database, e.g. an enterprise database, company database or similar data repositories or storage systems. According to this aspect, the second neural network is trained or configured to execute a PCA encoding operation to generate a smaller or lower dimension second candidate embeddings vector, as indicated by reference 628 in FIG. 6. The network comprises the encoder part of an autoencoder network with layers of dimensions, for example, (512->64->3)->(3->64->512). The encoder has one hidden layer with dense connections and RELU activation function. The decoder comprises a similar structure or configuration. During the training of the network, the average of L2 distances between the input and the output across the training sample of several thousand entries is minimized. The job embeddings vector 618 and the candidates embeddings vector 628 are stored in memory for further processing as described in more detail below.

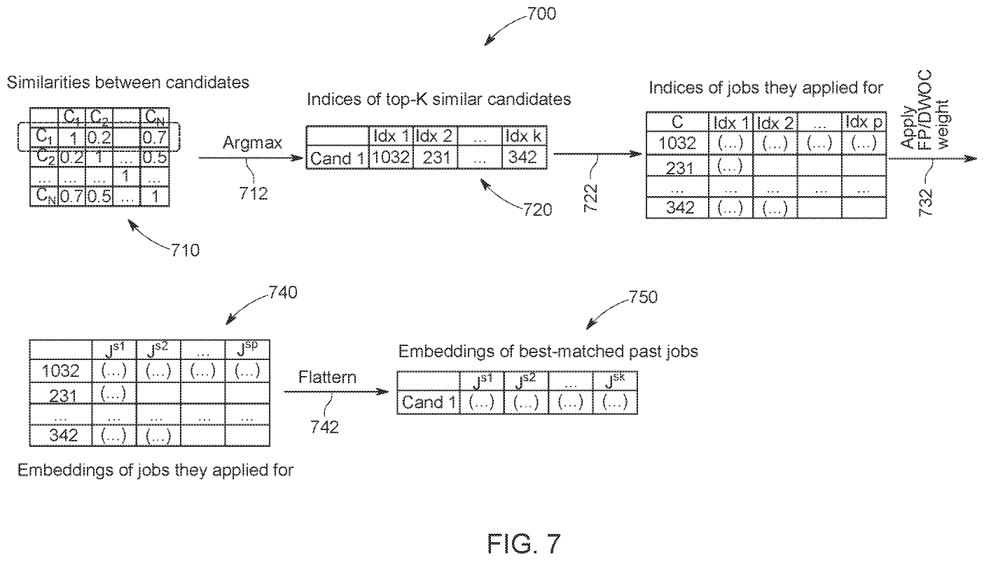

Reference is next made to FIG. 7, which shows in diagrammatic form a process for generating a best-matched past jobs embedding vector, and indicated generally by reference 700. The process 700 is configured to determine similarities between candidates as indicated by reference 710. The similarities are determined by applying a cosine similarity or cosine proximity operation to the candidates embedding vectors 628 (FIG. 6). As shown in FIG. 7, the process 700 is configured to apply “argmax” operation(s) to determine or generate indices of the top-K similar candidates, as indicated by reference 720. The process 700 is configured to then determine indices of the jobs the top-K candidates applied for, as indicate by reference 730 in FIG. 7. The process 700 is configured to next apply the indices of the jobs they applied for 730. and generate a jobs they applied for embeddings vector as indicated by reference 740. The FP/DWOC weightings are values generated from the machine learning operation based on historical successful applicants and unsuccessful applicants to jobs. Each successful applicant, e.g. someone selected to move forward to an interview, phone screen, or the like, is a first post. Each unsuccessful applicant, e.g. someone not qualified for the position or job, or someone with having a poor fit for the position or job based on their resume, is dismissed without contact. Each of these historical examples is utilized to contribute to the FP and DWOC weights of the machine learning model, and are further used as a comparison to determine, e.g. compute, the a fit between new candidates and jobs. According to an exemplary implementation, the jobs they applied for embedding vector 740 comprises, for example, a vector, showing the jobs each candidate applied to, for example, job vector after PCA: [−0.14820218, −0.15329292, −0.02573538], candidate vector after PCA: [−0.11469883, 0.11945762, −0.56683], the similarity score between the two is 0.53337693. For instance, Candidate 231 applied for jobs, i.e. similar jobs, J^{S1}, and Candidate 342 applied for jobs, i.e. similar jobs, J^{S1}, and J^{S2}, as shown in FIG. 7. According to an exemplary embodiment, the process 700 further includes a processing operation indicated by reference 742 in FIG. 7 to “flatten” the jobs they applied for embedding vector 740 and generate a best-matched past jobs embedding sentence vector denoted by reference 750. As shown, the best-matched past jobs vector 750 is configured for “Cand 1”, i.e. candidate 1, and comprises a plurality of best-match past jobs for the candidate, with each job indicated as “J^{S1} to J^{SK}”.

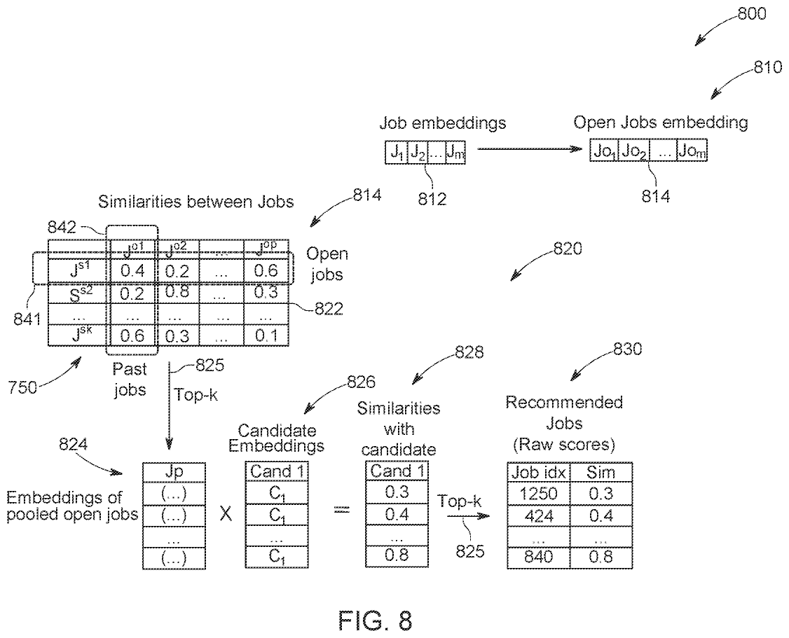

Reference is next made to FIG. 8, which shows a process indicated generally by reference 800 configured to generate one or more job recommendations for a candidate. As shown, the process for generating a job recommendation 800 includes an operation indicated by reference 810 to generate an open jobs embeddings vector 814 from the job embeddings vector 812 (denoted by reference 618 in FIG. 6 as described above). The job embeddings vector 812 comprises a plurality of job descriptors, indicated individually as J₁, J₂ . . . J_{N}. The job descriptions J_{N} are compared to jobs that are open or available and the open jobs embedding vector 814 is generated and comprises a plurality of open job descriptors, indicated individually as J^{O1}, J^{O2} . . . J^{Op}. As shown in FIG. 8, the next operation, indicated by reference 822, in the process 800 comprises determining “similarities” between the open jobs and the past jobs and generate a first top-K list 823 of recommended jobs for the candidate. According to an exemplary embodiment, the process generating a job recommendation 800 comprises utilizing the open jobs embeddings vector 814, and the best-matched past jobs embeddings vector 750 (as described above with reference to FIG. 7) to determine the similarities and generate the first top-K list 823. The similarities between the vectors 750 and 814 may be determined or calculated utilizing the cosine similarity or cosine proximity function, for example, as described above with reference to FIG. 2. According to an exemplary implementation, each job identifier is associated with a score. All jobs are sorted with the heap queue algorithm, for instance, implemented in a Python standard library module “heapq”, as will be understood by one skilled in the art. Based on the calculated similarities, the first top-K list 823 is generated and according to an exemplary embodiment comprises a list of 10 jobs.

Referring still to FIG. 8, the next processing step or operation according to an exemplary embodiment comprises generating a similarities with candidate vector 828 based on a pooled open jobs embedding vector 824 and a candidate embedding vector 826. The candidate embedding vector 826 corresponds to the candidate embeddings vector 628 (as described above with reference to FIG. 6). The pooled open jobs vector 824 is based on the first top-K list 823 and comprises a list of open jobs that have been pooled based on similarities between past jobs and open jobs, for instance, as determined in 822. According to an exemplary implementation, the similarity is defined as the cosine of the angle (radians) between the two vectors, normalized between 0 and 1, or according to a formula: 1−[arccos(cos ø)/π]. The similarities with candidate embeddings vector 828 as generated by the system comprises a vector with each element representing a “score” for the candidate based on the associated pooled open job. The similarities with candidate embeddings vector 828 is utilized to generate a final top-K job list 825 which is translated into a recommended jobs (raw scores) output, for example, depicted as a table or vector, for the candidate as indicated by reference 830. According to an exemplary implementation, the recommended jobs output 830 comprises a list or column of jobs, or job identifiers, indicated by “Job idx” and a corresponding list or column of raw similarity scores indicated by “Sim”. The jobs and associated similarity scores may be ranked in ascending order, i.e. lowest raw score to highest raw score, or in descending order. For example, the job having identifier “1250” has a calculated raw similarity score of “0.3” and the job having identifier “840” has a calculated raw similarity score of “0.8”. Accordingly, Job 840 is a better match than Job 1250 for Candidate 1. The recommended jobs according to the raw scores comprise a baseline recommendation, which is suitable or sufficient for practical application.

According to another embodiment of the present invention, the recommended jobs based on the raw scores may be further refined, re-ranked, or processed, based on additional or other parameters or details.

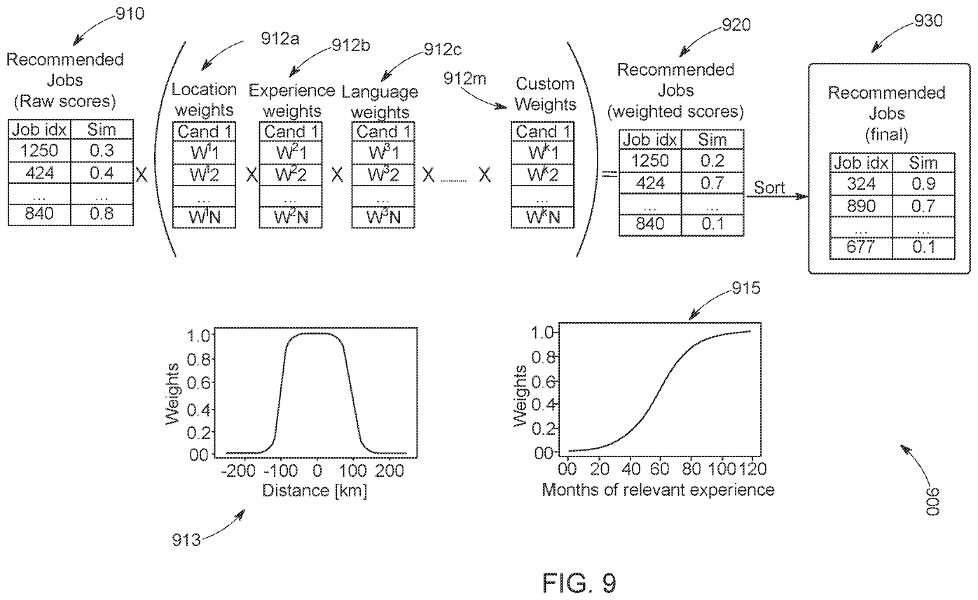

Reference is next made to FIG. 9, which shows a process for refining a recommendation according to an embodiment of the present invention and indicated generally by reference 900. The recommended jobs (raw scores) output 830 (FIG. 8) is depicted as a recommended jobs (raw scores) output or table indicated by reference 910 in FIG. 9. The process 900 is configured to apply one or more refinement factors or weighting parameters to the baseline jobs recommendations in the output 910. The weighting factors may comprise or include, location of the job; experience of the candidate; language requirement for the job; consistency of the candidate with other candidates and jobs for similar positions, and the like. According to an exemplary embodiment, the refinement process 900 is configured with a plurality of weighting vectors 912, and including a location weighting vector 912a, an experience weighting vector 912b, and a language weighting vector 912c. The weighting vectors 912 may include one or more customizable weighting vectors indicated generally by 912m. The refinement process 900 is configured to apply one or more of the weighting vectors 912 to the baseline (raw scores) jobs recommendation 910 and generate a refined or reweighted jobs recommendation output, for instance, a recommended jobs (weighted scores) output or table, as indicated by reference 920.

The location weighting vector 912a comprises a plurality a geographic distance weighting parameters or factors, based on the geographic location of the job in relation to the candidate. The distribution of the location weighting parameter is graphically represented as indicated by reference 913 in FIG. 9. The location weighting vector 912a can be further refined or weighted based on additional information or input. For example, if the candidate is willing to relocate to another city for a job, then the distance or geographic location weighting can be recalculated or adjusted.

The experience weighting vector 912b comprises a plurality of experience level weighting parameters or factors, for instance, a junior level or position, and a senior level or position. The distribution of the experience weighting parameter is graphically represented as indicated by reference 915 in FIG. 9. The experience weighting vector 912b can be further revised or redefined by an education history vector. For example, a candidate is a qualified professional, such as a CPA, but is looking for a job in an unrelated field and/or at a level inconsistent with the candidate's education or experience level.

Additional reweighting factors or parameters can be formulated or inferred from additional information sources or inputs. For instance, reweighting factors can be determined from direct answers to the applicant or the candidate.

Referring again to FIG. 9, the recommended jobs (weighted scores) output 920 can be further refined or reorganized. For instance, the process 900 is configured to rank the recommended jobs according to the “SIM” score. As shown, the recommended jobs “Job idx” are ranked according to the associated similarity score “SIM”, in descending order with the job, i.e. Job idx 324, with the highest score SIM=0.9 being ranked first.

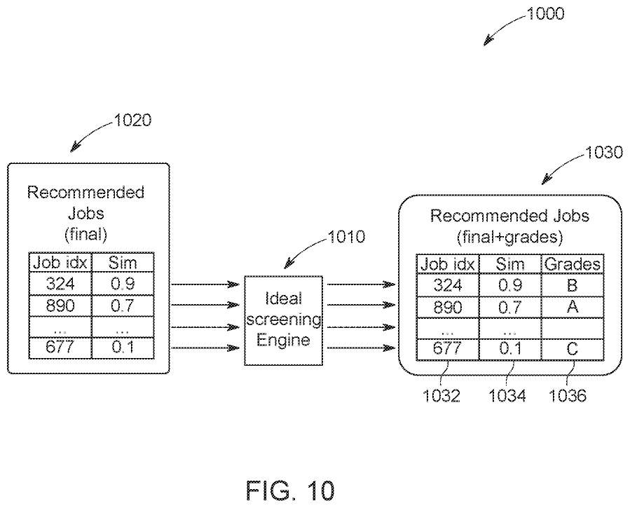

Reference is next made to FIG. 10, which shows in diagrammatic form a process for generating a grading, for instance a preliminary grading, according to an embodiment and indicated generally by reference 1000. The grading process 1000 may be implemented as an optional step, for example, activated or deactivated based on a particular or specific application or recruitment operation.

According to an exemplary implementation, the grading process 1000 comprises a screening engine 1010 configured to generate a grading, i.e. a grade, for each recommended job. As shown in FIG. 10, the grading process 1000 comprises applying the recommended jobs output (for example, as described in more detail above) indicated by reference 1020 to the screening engine 1010. The screening engine 1010 is configured (i.e. trained) to process information uploaded by the prospective candidate, for example, the candidate's resume and other relevant information, to generate an estimate of the likelihood of the candidate being a good match and a not so good match for the recommended job role or position. According to an exemplary embodiment, the estimate of the likelihood of the candidate being a good match comprises grade A, B, C or D. According to an exemplary implementation, a Grade “A” or Grade “B” indicates a “good match”, and a Grade “C” or a Grade “D” indicates a less than good or ideal match. The screening engine 1010 is configured to generate a Recommended Jobs output 1030 (for example, depicted as a Table) and including a Grade column indicated by reference 1036. The recommended jobs output 1030 includes a list or column of jobs, or job identifiers, indicated by “Job idx” and reference 1032, and a corresponding list or column of raw similarity scores indicated by “Sim” and reference 1034. It will be appreciated that according to this embodiment, the generated “grades” are not utilized by the grading process 1000 to re-order the recommended job results. Rather, the “grades” provide additional information which can complement the recommend job outputs.

According to an exemplary implementation, the screening engine 1010 is trained on a sufficient number of past examples or instances of job applicants/applications for job roles or positions corresponding to or similar to the recommended job roles or positions.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. A computer-implemented system for determining a recommendation for a candidate for a selected job in an organization, said system comprising:
a processor operatively coupled to a database and including an input component configured to retrieve data associated with the candidate;
a first network configured to generate a first vector comprising a representation of said data associated with the candidate, said first vector having a first dimension;
a second network configured to generate a second vector based on said first vector, said second vector comprising a second dimension, and said second dimension being less than the first dimension of said first vector;
said processor including a comparison component configured to compare said second vector to one or more vectors wherein each of said one or more vectors represents a job in the organization; and
said processor including a component configured to be responsive to said comparison component and generate a match rating based on the comparison of said second vector and said one or more job vectors.

2. The system as claimed in claim 1, wherein said first network comprises a neural network configured to transform said data associated with the candidate into said first vector utilizing sentence embedding.

3. The system as claimed in claim 2, wherein said second network is configured to execute a non-linear principal component analysis (PCA) to generate said second vector.

4. The system as claimed in claim 3, wherein said comparison component is configured to determine a proximity value between said second vector and each of said one or more job vectors, and each of said proximity values representing a match rating between the candidate and the corresponding job.

5. A computer-implemented method for determining a recommendation for a candidate for a selected job in an organization said method comprising the steps of:
inputting data from a database associated with the candidate for the selected job;
generating a first vector comprising a representation of said data associated with the candidate, said first vector having a first dimension;
generating a second vector based on said first vector, said second vector comprising a second dimension, and said second dimension being less than the first dimension of said first vector;
comparing said second vector to one or more vectors wherein each of said one or more vectors represents a job in the organization; and
generating a match rating based on the comparison of said second vector and said one or more job vectors.

6. The computer-implemented method as claimed in claim 5, wherein said step of generating a first vector comprises applying said inputted data to a first neural network and said first neural network being configured to generate said first vector having a first dimension.

7. The computer-implemented method as claimed in claim 5, wherein said step of generating a second vector comprises applying said first vector to a second neural network and said second neural network being configured to execute a non-linear principal component analysis (PCA) to generate said second vector having a second dimension.

8. The computer-implemented method as claimed in claim 7, wherein said step of comparing comprises determining a proximity value between said second vector and each of said one or more job vectors, and each of said proximity values representing a match rating between the candidate and the corresponding job.

9. The computer-implemented method as claimed in claim 8, further including said step of generating a grade for each of the job recommendations.

10. A computer program product for determining a recommendation for a candidate for a selected job in an organization, said computer program product comprising:
a non-transitory storage medium configured to store computer readable instructions;
said computer readable instructions including instructions for,
inputting data from a database associated with the candidate for the selected job;
generating a first vector comprising a representation of said data associated with the candidate, said first vector having a first dimension;
generating a second vector based on said first vector, said second vector comprising a second dimension, and said second dimension being less than the first dimension of said first vector;
comparing said second vector to one or more vectors wherein each of said one or more vectors represents a job in the organization; and
generating a match rating based on the comparison of said second vector and said one or more job vectors.

11. The computer program product as claimed in claim 10, wherein said operation of generating a first vector comprises applying said inputted data to a first neural network and said first neural network being configured to generate said first vector having a first dimension.

12. The computer program product as claimed in claim 10, wherein said operation of generating a second vector comprises applying said first vector to a second neural network and said second neural network being configured to execute a non-linear principal component analysis (PCA) to generate said second vector having a second dimension.

13. The computer program product as claimed in claim 12, wherein said operation of comparing comprises determining a proximity value between said second vector and each of said one or more job vectors, and each of said proximity values representing a match rating between the candidate and the corresponding job.

14. The computer program product as claimed in claim 12, further including executable instructions for generating a grade for each of the job recommendations.
